(19) United States
(12) Patent Application Publication
(10) Pub. No.: US 2018/0225942 A1
(43) Pub. Date: Aug. 9, 2018

(54) AUDIBLE SENSOR CHIP

(71) Applicants: Mobel Fadeyi, Denver, CO (US); Segun Oke, Denver, CO (US)

(72) Inventors: Mobel Fadeyi, Denver, CO (US); Segun Oke, Denver, CO (US)

(21) Appl. No.: 15/426,195

(22) Filed: Feb. 7, 2017

(51) Int. Cl. G08B 13/196

(52) U.S. Cl. CPC G08B 13/19636

(57) ABSTRACT

An audible sensor chip that includes: a base border; speakers on opposing sides of the chip; a control processor; and a camera. The speakers may include four speakers, where two speakers are on each side of a center console. Preferably, the camera is positioned at the center of the console.

### BACKGROUND OF THE INVENTION

### Field of Invention

The present invention relates to an audible sensor chip that is mountable to provide security in various locations.

### Description of Related Art

Security systems are readily available in various forms and for various facilities, buildings, homes and other locations. The typical security system includes sensors to detect motion, recording capabilities in terms of cameras and audible alarms to alert of intrusion. The object of the present invention is to provide an improvement onto existing alarm systems, cameras and computers to provide a sensor chip to provide audible alerts from a series of speakers.

### SUMMARY OF THE INVENTION

The present invention relates to an audible sensor chip that includes: a base border; speakers on opposing sides of the chip; a control processor; and a camera. The speakers may include four speakers, where two speakers are on each side of a center console. Preferably, the camera is positioned at the center of the console.

### BRIEF DESCRIPTION OF DRAWINGS

FIG. 1 depicts an audible sensor chip in accordance with the present invention.

### DETAILED DESCRIPTION

The present invention relates to audible sensor chip that is used to emit audible alerts through a series of speakers. This audible alert provides accessory or addition to an existing alarm system therefore alerting of any suspicious behavior or particular movement. The security sensor chip according to present inventions includes a camera with speakers surrounding the camera on a mountable console. The console includes a magnetic base that allows the magnetic mounting of the sensor chip. Once magnetically mounted the sensor chip has a camera that operates to detect movement. Any movement detected can therefore trigger audible alerts from speakers on the sensor chip.

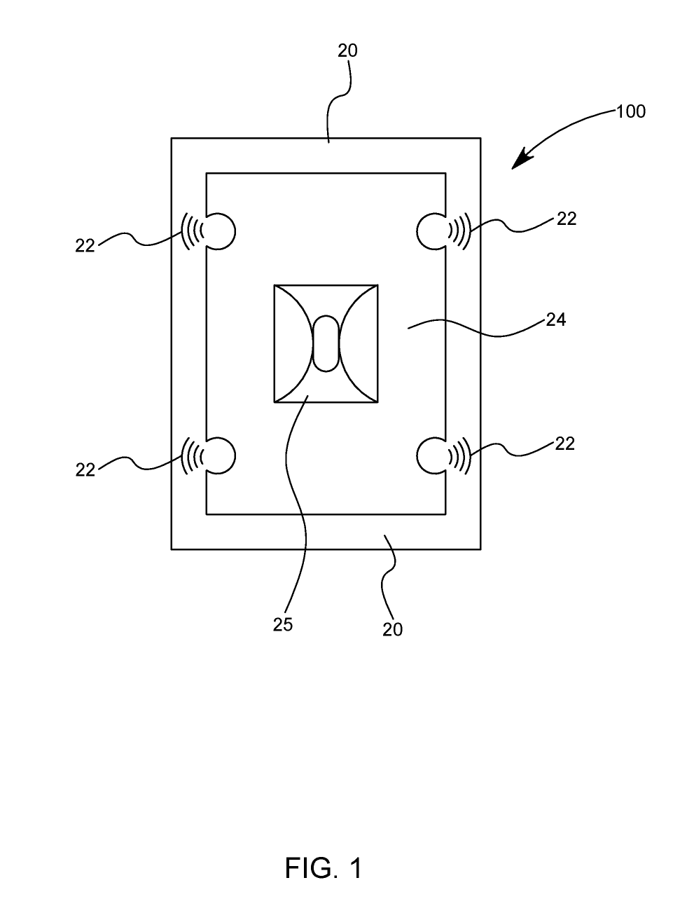

In reference to FIG. 1, a sensor chip 100 is depicted. The sensor chip 100 includes a rectangular base border 20 with a magnetic attribute. This feature allows the sensor chip 100 to be easily mounted onto a metal surface as needed by the user. Speakers 22 are provided on opposing sides of the sensor chip 100 on the border of a center console 24. At the center of the center console 24 is a camera 25 that detects movement. Appropriate processing controls are provided within the sensor chip 100 to detect movement through the camera 25 and then emit audible alerts through speakers 22 on each opposing side of the center console 24. The magnetic attributes of the base border 20 allows for easy mounting of the sensor chip in any position needed by the user. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An audible sensor chip comprising:
a. a base border;
b. speakers on opposing sides of the chip;
c. a control processor; and
d. a camera.

2. The audible sensor chip according to claim 1, where the speakers include four speakers.

3. The audible sensor chip according to claim 2, where two speakers are on each side of a center console.

4. The audible sensor chip according to claim 3, where the camera is positioned at the center of the console.
